(19) United States
(12) Patent Application Publication
(10) Pub. No.: US 2022/0242068 A1
(43) Pub. Date: Aug. 4, 2022

(54) PROCESS FOR PRODUCTION OF FIBER REINFORCED TAPE

(71) Applicant: SABIC GLOBAL TECHNOLOGIES B.V., Bergen op Zoom (NL)

(72) Inventors: Supriya MV, Geleen (NL); Bhaskar Patham, Geleen (NL); Jose Sales-Fernandez, Geleen (NL); Qin Yuan, Geleen (NL); Frank Heessels, Geleen (NL); Carmela Tufano, Geleen (NL)

(21) Appl. No.: 17/610,995

(22) PCT Filed: May 11, 2020
(86) PCT No.: PCT/EP2020/063052

§ 371 Date: Nov. 12, 2021

(30) Foreign Application Priority Data
May 13, 2019 (EP) 19174028.1

(51) Int. Cl. B29C 70/52; B29C 48/08; B29C 48/00; B29C 48/156; B29C 48/285; B29C 48/91; B29C 48/88; B29C 70/20

(52) U.S. Cl. CPC B29C 70/521; B29C 48/08; B29C 48/0011; B29C 48/0022; B29C 48/156; B29C 48/2886; B29K 2021/003; B29C 48/914; B29C 48/919; B29C 70/20; B29C 70/528; B29C 2793/0027; B29C 2793/009; B29C 48/91

(57) ABSTRACT

The invention relates to a process for the production of a tape comprising a plurality of impregnated continuous multifilament strands and a polymer sheath which intimately surrounds the plurality of impregnated continuous multifilament strands, wherein each of the plurality of impregnated multifilament strands extends in the longitudinal direction, wherein each of the plurality of impregnated continuous multifilament strands comprises at least one continuous glass multifilament strand, wherein the at least one continuous glass multifilament strand is impregnated with an impregnating agent, wherein the process comprising the steps of a) unwinding from a package the continuous glass multifilament strands, b) applying the impregnating agent to the continuous glass multifilament strands to form the plurality of impregnated continuous multifilament strands, c) placing the plurality of impregnated continuous multifilament strands in parallel alignment in the longitudinal direction and d) applying a sheath of a thermoplastic polymer composition around the plurality of impregnated continuous multifilament strands of step c) to form the tape, wherein steps c) and d) are performed in a die having a guiding means arranged for placing the plurality of impregnated continuous multifilament strands in parallel alignment in the longitudinal direction, wherein the plurality of impregnated continuous multifilament strands pass through a melt of the thermoplastic polymer composition inside of the die downstream of the guiding means.

The present invention relates to a process for the production of a fiber reinforced tape. The invention further relates to such tape, to a laminate or a woven fabric prepared from said tape, to an article comprising said tape or said laminate or woven fabric and to the use of said tape and laminate and woven fabric in applications, such as automotive applications.

Introduced more than a half century ago, fibre-reinforced plastics are composite materials with a wide range of applications in industry, for example in the automotive industry. The term “composite” can apply to any combination of individual materials, for example to a thermoplastic polymer (the matrix) in which fibres (reinforcing filler) have been dispersed. The reinforced plastics industry has used glass fibres in different forms for reinforcing polymer matrices to produce a diversity of products.

In the production of short glass fibre compositions or compounds, chopped strands of pre-determined length are mixed with a thermoplastic polymer in an extruder, during which the integrity of the glass fibre strands is destroyed and the glass fibres are dispersed throughout the molten thermoplastic polymer; due to fibre breakage the fibre length is decreased during this process, typically to well below 1 mm. Long glass fibre-reinforced polymer compositions contain glass fibres having a length of at least 1 mm, often at least 2 mm and typically between 5 and 20 mm. As a result, glass fibres in moulded articles made from long glass fibre-reinforced polymer compositions generally are of higher length than in articles made from short glass fibre compositions, resulting in better mechanical properties. For that reason long glass fibre-reinforced polymer compositions are preferred for applications wherein good mechanical properties are necessary.

However, reinforcement of a thermoplastic polymer by using glass adds a lot of weight to an article, since the thermoplastic polymer generally has a lower density than glass. In order to be able to prepare light weight articles, which still have sufficient strength, in recent years, long glass fibre-reinforced tapes have been introduced into the market to allow for the production of light-weight articles with sufficient strength due to the use of the reinforcing tape.

A special class of tapes are unidirectional tapes, which are tapes that have fibers that extend substantially in the longitudinal direction. Such unidirectional tapes are typically used to prepare articles having properties that vary in one or more directions or dimensions.

Examples of unidirectional glass fiber tapes are known from WO2016/142784A1. WO2016/142784A1 discloses a fiber-reinforced composite comprising:

a matrix material including a thermoplastic material; and

a non-woven fibrous region comprising a plurality of continuous fibers dispersed in the matrix material;

wherein the width and the length of the non-woven fibrous region are substantially equal to the width and the length, respectively, of the fiber-reinforced composite;

wherein the non-woven fibrous region has a mean relative fiber area coverage (RFAC) (%) of from 65 to 90 and a coefficient of variance (COV) (%) of from 3 to 20; and

wherein each of the plurality of continuous fibers is substantially aligned with the length of the fiber-reinforced composite.

Unidirectional composite fiber prepregs are for example described in WO2011/163365 A2 and composite fiber profiles are for example described in WO2011/156693 A2.

Reinforced composites from thermoplastic materials combine the stiffness provided by the reinforcement with the advantageous properties of a thermoplastic material, such as easy molding and plying of the material above a certain temperature and solidification below that temperature.

There is a need in the art for providing a unidirectional glass fiber tape in an efficient manner.

It is an object of the invention to provide a unidirectional glass fiber tape in an efficient manner.

This object is achieved by a process for the production of a tape comprising a plurality of impregnated continuous multifilament strands and a polymer sheath which intimately surrounds the plurality of impregnated continuous multifilament strands,

wherein each of the plurality of impregnated multifilament strands extends in the longitudinal direction,

wherein each of the plurality of impregnated continuous multifilament strands comprises at least one continuous glass multifilament strand, wherein the at least one continuous glass multifilament strand is impregnated with an impregnating agent,

wherein the process comprising the steps of

a) unwinding from a package the continuous glass multifilament strands,

b) applying the impregnating agent to the continuous glass multifilament strands to form the plurality of impregnated continuous multifilament strands,

c) placing the plurality of impregnated continuous multifilament strands in parallel alignment in the longitudinal direction and

d) applying a sheath of a thermoplastic polymer composition around the plurality of impregnated continuous multifilament strands of step c) to form the tape,

wherein steps c) and d) are performed in a die having a guiding means arranged for placing the plurality of impregnated continuous multifilament strands in parallel alignment in the longitudinal direction, wherein the plurality of impregnated continuous multifilament strands pass through a melt of the thermoplastic polymer composition inside of the die downstream of the guiding means.

According to the present invention, a sheath is applied around a group of parallel impregnated continuous multifilament strands. The process advantageously provides a tape by a simple process with a small number of steps.

The number of the impregnated continuous multifilament strands in the plurality of the impregnated continuous multifilament strands used in the process according to the present invention is preferably at least 4, for example the number of impregnated continuous multifilament strands in the plurality of the impregnated continuous multifilament strands is in the range between 4 to 40, preferably in the range between 4 to 24.

Steps a)-b) are described in detail in WO2009/080281A1, which document is hereby incorporated by reference.

Before the sheath is applied in step d), the impregnated strands are placed in parallel alignment in step c) preferably in one plane, wherein preferably the distance between adjacent strands is essentially the same and/or for example the distance between adjacent strands is in the range from 0.20 to 2.3 mm. “Essentially the same” means the distance between adjacent strands does not differ for more than 8%. This is preferably performed in a die arranged for the parallel alignment of strands as well as the application of sheath.

Accordingly, preferably, steps c) and d) are performed in a die having a guiding means arranged for placing the plurality of impregnated continuous multifilament strands in parallel alignment in the longitudinal direction, wherein the plurality of impregnated continuous multifilament strands pass through a melt of the thermoplastic polymer composition inside of the die downstream of the guiding means.

In some embodiments, the guiding means is provided with a plurality of extended holes in parallel alignment in the longitudinal direction and arranged in one plane, wherein each of the extended holes is arranged for accommodating one impregnated continuous multifilament strand. In such embodiments, a precise parallel arrangement of the impregnated strands in the final tape is ensured and a good product exterior is also ensured. Moreover, the breakage of the impregnated strands due to friction with each other is avoided. It is further ensured that the thermoplastic polymer composition is present between impregnated continuous multifilament strands.

In other embodiments, the guiding means is provided with one extended hole having an elliptical cross section, wherein the extended hole is arranged for accommodating the plurality of impregnated continuous multifilament strands in one plane. This has an advantage that the manufacturing of such guiding means is easy.

According to the invention, it is ensured by step c) that the strands are in the desired arrangement in the final tape before the step of applying the sheath. It is however possible that the plurality of continuous glass multifilament strands are already arranged in parallel alignment before the application of the impregnating agent e.g. by means of a guiding system upstream of the die for the application of the impregnating agent, wherein preferably the plurality of continuous glass multifilament strands is in one plane, wherein preferably the distance between the adjacent strands is essentially the same, for example the distance between the adjacent strands is in the range between 0.20 to 2.3 mm. “Essentially the same” means the distance between adjacent strands does not differ for more than 8%. This may assist in ensuring that the strands are in parallel arrangement in step c). It is also possible that the plurality of continuous glass multifilament strands are arranged in parallel alignment in the die for the application of the impregnating agent, wherein preferably the plurality of continuous glass multifilament strands is in one plane, wherein preferably the distance between the adjacent strands is essentially the same, for example the distance between the adjacent strands is in the range between 0.20 to 2.3 mm. “Essentially the same” means the distance between adjacent strands does not differ for more than 8%.

The tape obtained by step d) may be subjected to the step e) of applying pressure and optional heat for adjusting the thickness of the tape and compacting the tape.

Step e) is preferably performed by the steps of

e1) applying pressure on while optionally heating the tape and

e2) cooling and solidifying the product obtained by step e1), e.g. by chill rolls, a water bath, a blower a fan or a high speed air knife,

Step e1) is preferably performed by sequential steps of

e1a) maintaining the tape of step d) in its melted state, e.g. by subjecting the tape of step d) to an elevated temperature, e.g. by hot rolls, flat belts, an oven or a belt press and

e2a) applying pressure on the tape obtained by step d) to adjust the thickness of the tape and compact the tape, e.g. by calendaring rolls.

Step e1a) improves the impregnation of the thermoplastic polymer into the impregnated continuous multifilament strands, which results in improved tape properties.

Examples of units for performing step e1a) include hot rolls, flat belts, an oven and a belt press. The use of hot rolls for step e1a) has an advantage that it can be performed at a high speed. The advantage of using flat belts or belt press is that the tape directly contact with the belt to achieve a good heat transfer, which results in a better impregnation. In case step e1b) is performed at a lower temperature than step e1a), the impregnation of the impregnated continuous multifilament strands in the thermoplastic polymer may be improved. This step e) further results in tapes with improved properties, for example it may result in tapes having a good surface quality and/or may improve the mechanical properties of the tape. The solidified shape of the tape achieved after step e2 allows for further processing or handling of the tape. This can be performed using chill rolls, which advantageously achieves a relatively slow cooling to reduce shrinkage. Some other possible cooling methods are water bath, blower, fan, high speed air knife, etc. These technologies can reach fast cooling, especially water bath.

The process may further comprise the step f) of cutting the tape obtained by step e) into desired length, which may be stacked or wound.

Preferably, the tape obtained by step d) is subjected to step e) without cutting.

In these embodiments, the steps for making the tape a)-d) and steps e) are performed in one manufacturing system. The process can be performed as a continuous process, i.e. the continuous glass multifilament strands are continuously unwound for use in the process as the tape with improved properties is formed continuously by the process.

Compared to a process where the tape obtained by step d) is cut into desired length and then subjected to a step of improving its mechanical properties, the continuous process is easier to operate since it does not require many separate procedures. This results in a lower manufacturing cost. Moreover, the variations in the properties of tapes produced by the continuous process, such as tensile, flexural and impact properties, are small.

Preferably, the process of the invention involves no cutting until the tape of step d) is formed. Accordingly, preferably, the continuous glass multifilament strands unwound in step a) and the impregnated continuous multifilament strands formed in step b) are not cut during steps a)-d).

In other embodiments, the tape obtained by step d) may be cut into desired length. Accordingly, the process may further comprise the step g) of cutting the tape obtained by step d) into desired length.

The cut tape obtained by step g) may be subjected to heat and pressure for improving its mechanical properties, in a similar manner as step e) described above. Accordingly, in some embodiments, the process further comprises the step h) of applying heat and pressure to the tape obtained by step g) in the plane direction preferably by sequential steps of

g1) heating and applying pressure on the tape and

g2) cooling and solidifying the product obtained by step g1), e.g. by chill rolls, a water bath, a blower a fan or a high speed air knife, wherein g1) is preferably performed by sequential steps of

g1a) melting the tape of step d), e.g. by hot rolls, flat belts, an oven or a belt press and

g2a) applying pressure on the product obtained by step g1a), e.g. by calendaring rolls.

In another aspect, the invention relates to a tape obtained or obtainable by the process of the invention.

In another aspect, the invention relates to a laminate of a plurality of tapes of the invention. Within the framework of the invention, with ‘laminate’ is meant an arrangement in which at least two plies (layers) of the tapes of the invention are present. For example, such laminate contains 2, 3, 4, 5, 6, 7, 8, 9, 10, or more plies, wherein one ply consists of the tape of the invention. For example, in the laminate, the plies may be positioned such that their respective sheathed continuous multifilament strands are not parallel to each other. In case their respective sheathed continuous multifilament strands are positioned in relation to one other in a substantially 90° angle, such laminate is usually referred to as cross-ply. Laminates of the invention can for example be assembled or processed into two-dimensional or three-dimensional structures, such as, for example, via winding and/or lay-up techniques.

In another aspect, the invention relates to a woven fabric made of a plurality of tapes of the invention. Any known methods for weaving tapes into a woven fabric may be used.

In another aspect, the invention relates to an article comprising the tape of the invention, the consolidated laminate of the invention or the woven fabric of the invention.

The tapes, laminates, woven factices or articles of the invention can for example be used in an automotive application.

It has been found that the impact energy per unit of thickness is higher for the tapes according to the invention which contain wax (impregnating agent) as compared to the tapes which do not have wax in their composition. In addition, the E-modulus (also known as Young's modulus or stiffness) may be increased by the tapes of the invention as well.

Therefore, for tapes according to the invention, the impact energy per unit of thickness as measured according to the method as described herein is higher as compared to tapes from a plurality of sheathed continuous multifilament strands having a core that is not impregnated with an impregnating agent.

In the context of the invention with ‘tape’ is meant an object whose thickness is very thin in relation to its length and width. That is, the tape has a high width to thickness ratio. Typically the width of a tape is between 1-1500 times, for example 2-100 times larger than the thickness. The length of the tape can be indefinite. The tape may have a rectangular cross-, but may also have profiled sections (corrugated, ribbed etc.).

Typically, the tape obtained by step d) has a thickness in the range from 0.1 to 10 mm, for example 0.8 to 4 mm, and/or a width in the range from 1 to 4000 mm, for example 10 to 400 mm, for example 3 to 50 mm.

Typically, the tape obtained by step e) or step g) has a thickness in the range from 0.1 to 10 mm, for example 0.5 to 3 mm, and/or a width in the range from 1 to 4000 mm, for example 10 to 400 mm, for example 3 to 50 mm.

In the context of the invention with ‘extends in the longitudinal direction’ is meant ‘oriented in the direction of the long axis of the impregnated continuous multifilament strand.

The impregnated continuous multifilament strand is prepared from a continuous glass multifilament strand and an impregnating agent.

The term intimately surrounding as used herein is to be understood as meaning that the polymer sheath substantially entirely contacts the plurality of impregnated continuous multifilament strands. Said in another way the sheath is applied in such a manner onto the plurality of impregnated continuous multifilament strands that there is no deliberate gap between an inner surface of the sheath and the impregnated continuous multifilament strands.

Glass fibres are generally supplied as a plurality of continuous, very long filaments, and can be in the form of strands, rovings or yarns. A filament is an individual fibre of reinforcing material. A strand is a plurality of bundled filaments. Yarns are collections of strands, for example strands twisted together. A roving refers to a collection of strands wound into a package.

For purpose of the invention, a glass multifilament strand is defined as a plurality of bundled glass filaments.

Glass multifilament strands and their preparation are known in the art.

The filament density of the continuous glass multifilament strand may vary within wide limits. For example, the continuous glass multifilament strand may have at least 500, for example at least 1000 glass filaments/strand and/or at most 10000, for example at most 5000 grams per 1000 meter. Preferably, the amount of glass filaments/strands is in the range from 500 to 10000 grams per 1000 meterglass filaments/strand.

The thickness of the glass filaments is preferably in the range from 5 to 50 μm, more preferably from 10 to 30 μm, even more preferably from 15 to 25 μm. Usually the glass filaments are circular in cross section meaning the thickness as defined above would mean diameter. The glass filaments are generally circular in cross section.

The length of the glass filaments is in principle not limited as it is substantially equal to the length of the sheathed continuous multifilament strand. For practical reasons of being able to handle the tape however, it may be necessary to cut the sheathed continuous multifilament strand into a shorter strand. For example the length of the sheathed continuous multifilament strand is at least 1 m, for example at least 10 m, for example at least 50 m, for example at least 100m, for example at least 250 m, for example at least 500m and/or for example at most 25 km, for example at most 10 km.

Preferably, the continuous glass multifilament strand in the tape of the invention comprises at most 2 wt %, preferably in the range from 0.10 to 1 wt % of a sizing based on the continuous glass multifilament strand. The amount of sizing can be determined using ISO 1887:2014.

A sizing composition is typically applied to the glass filaments before the glass filaments are bundled into a continuous glass multifilament strand.

Suitable examples of sizing compositions include solvent-based compositions, such as an organic material dissolved in aqueous solutions or dispersed in water and melt- or radiation cure-based compositions. Preferably, the sizing composition is an aqueous sizing composition.

As described in the art, e.g. in documents EP1460166A1, EP0206189A1 or U.S. Pat. No. 4,338,233, the aqueous sizing composition may include film formers, coupling agents and other additional components.

The film formers are generally present in effective amount to protect fibres from interfilament abrasion and to provide integrity and processability for fibre strands after they are dried. Suitable film formers are miscible with the polymer to be reinforced. For example; for reinforcing polypropylenes, suitable film formers generally comprise polyolefin waxes.

The coupling agents are generally used to improve the adhesion between the matrix thermoplastic polymer and the fibre reinforcements. Suitable examples of coupling agents known in the art as being used for the glass fibres include organofunctional silanes. More particularly, the coupling agent which has been added to the sizing composition is an aminosilane, such as aminomethyl-trimethoxysilane, N-(beta-aminoethyl)-gamma-aminopropyl-trimethoxysilane, gamma-aminopropyl-trimethoxysilane gamma-methylaminopropyl-trimethoxysilane, delta-aminobutyl-triethoxysilane, 1,4-aminophenyl-trimethoxysilane. Preferably, in the tape of the invention, the sizing composition contains an aminosilane to enable a good adhesion to the thermoplastic matrix. The sizing composition may further comprise any other additional components known to the person skilled in the art to be suitable for sizing compositions. Suitable examples include but are not limited to lubricants (used to prevent damage to the strands by abrasion) antistatic agents, crosslinking agents, plasticizers, surfactants, nucleation agents, antioxidants, pigments as well as mixtures thereof.

Typically, after applying the sizing composition to the glass filaments, the filaments are bundled into the continuous glass multifilament strands and then wound onto bobbins to form a package.

In the tape of the invention, the impregnated continuous multifilament strand is prepared from a continuous glass multifilament strand and an impregnating agent and in particular by applying an impregnating agent to the continuous glass multifilament strand preferably in an amount from 0.50 to 18.0 wt %, for example from 0.5 to 10.0 wt % or for example from 10.0 to 18.0 wt % based on the sheathed continuous multifilament strands.

The optimal amount of impregnating agent applied to the continuous glass multifilament strand depends on the polymer sheath, on the size (diameter) of the glass filaments forming the continuous glass strand, and on the type of sizing composition. Typically, the amount of impregnating agent applied to the continuous glass multifilament strand is for example at least 0.50 wt %, preferably at least 1.0 wt %, preferably at least 1.5 wt %, preferably at least 2 wt %, preferably at least 2.5 wt % and/or at most 10.0 wt %, preferably at most 9.0 wt %, more preferably at most 8.0 wt %, even more preferably at most 7.0 wt %, even more preferably at most 6.0 wt %, even more preferably at most 5.5 wt %, or for example at least 10.0 wt %, preferably at least 11 wt %, preferably at least 12 wt % and/or at most 18 wt %, preferably at most 16 wt %, preferably at most 14% based on the amount of sheathed continuous multifilament strands. Preferably, the amount of impregnating agent is in the range from 1.5 to 8 wt %, even more preferably in the range from 2.5 wt % to 6.0 wt % based on the sheathed continuous multifilament strand. A higher amount of impregnating agent increases the Impact Energy per unit of thickness (J/mm). However, for reasons of cost-effectiveness and low emissions (volatile organic compounds) and mechanical properties, the amount of impregnating agent should also not become too high.

For example, the ratio of impregnating agent to continuous glass multifilament strand is in the range from 1:4 to 1:30, preferably in the range from 1:5 to 1:20.

Preferably, the viscosity of the impregnating agent is in the range from 2.5 to 200 cSt at 160° C., more preferably at least 5.0 cSt, more preferably at least 7.0 cSt and/or at most 150.0 cSt, preferably at most 125.0 cSt, preferably at most 100.0 cSt at 160° C.

An impregnating agent having a viscosity higher than 100 cSt is difficult to apply to the continuous glass multifilament strand. Low viscosity is needed to facilitate good wetting performance of the fibres, but an impregnating agent having a viscosity lower than 2.5 cSt is difficult to handle, e.g., the amount to be applied is difficult to control; and the impregnating agent could become volatile. For purpose of the invention, unless otherwise stated, the viscosity of the impregnating agent is measured in accordance with ASTM D 3236-15 (standard test method for apparent viscosity of hot melt adhesives and coating materials, Brookfield viscometer Model RVDV 2, #27 spindle, 5 r/min) at 160° C.

Preferably, the melting point of (that is the lowest melting temperature in a melting temperature range) the impregnating agent is at least 20° C. below the melting point of the thermoplastic polymer composition. More preferably, the impregnating agent has a melting point of at least 25 or 30° C. below the melting point of the thermoplastic polymer composition. For instance, when the thermoplastic polymer composition has a melting point of about 160° C., the melting point of the impregnating agent may be at most about 140° C.

Suitable impregnating agents are compatible with the thermoplastic polymer to be reinforced, and may even be soluble in said polymer. The skilled man can select suitable combinations based on general knowledge, and may also find such combinations in the art.

Suitable examples of impregnating agents include low molar mass compounds, for example low molar mass or oligomeric polyurethanes, polyesters such as unsaturated polyesters, polycaprolactones, polyethyleneterephthalate, poly(alpha-olefins), such as highly branched polyethylenes and polypropylenes, polyamides, such as nylons, and other hydrocarbon resins.

For reinforcing polypropylenes, the impregnating agent preferably comprises highly branched poly(alpha-olefins), such as highly branched polyethylenes, modified low molecular weight polypropylenes, mineral oils, such as, paraffin or silicon and any mixtures of these compounds.

The impregnating agent preferably comprises at least 20 wt %, more preferably at least 30 wt %, more preferably at least 50 wt %, for example at least 99.5 wt %, for example 100 wt % of a branched poly(alpha-olefin), most preferably a branched polyethylene. To allow the impregnating agent to reach a viscosity of from 2.5 to 200 cSt at 160° C., the branched poly(alpha-olefin) may be mixed with an oil, wherein the oil is chosen from the group consisting of of mineral oils, such as a paraffin oil or silicon oil; hydrocarbon oils; and any mixtures thereof.

Preferably, the impregnating agent is non-volatile, and/or substantially solvent-free. In the context of the present invention, non-volatile means that the impregnating agent has a boiling point or range higher than the temperatures at which the impregnating agent is applied to the continuous multifilament glass strand. In the context of present invention, “substantially solvent-free” means that impregnating agent contains less than 10 wt % of solvent, preferably less than 5 wt % of solvent based on the impregnating agent. In a preferred embodiment, the impregnating agent does not contain any organic solvent.

The impregnating agent may further be mixed with other additives known in the art.

Suitable examples include lubricants; antistatic agents; UV stabilizers; plasticizers; surfactants; nucleation agents; antioxidants; pigments; dyes; and adhesion promoters, such as a modified polypropylene having maleated reactive groups; and any combinations thereof, provided the viscosity remains within the desired range. Any method known in the art may be used for applying the liquid impregnating agent to the continuous glass multifilament strand. The application of the liquid impregnating agent may be performed using a die. Other suitable methods for applying the impregnating agent to the continuous multifilament strands include applicators having belts, rollers, and hot melt applicators. Such methods are for example described in documents EP0921919B1 EP0994978B1, EP0397505B1, WO2014/053590A1 and references cited therein. The method used should enable application of a constant amount of impregnating agent to the continuous multifilament strand.

The polymer sheath consists of a thermoplastic polymer composition. Preferably, the melt flow rate (MFR) of the thermoplastic polymer is in the range from 20 to 150 dg/min, preferably in the range from 25 to 120 dg/min, for example in the range from 35 to 100 dg/min as measured according to ISO1133 (2.16 kg/230° C.).

The thermoplastic polymer composition preferably comprises a thermoplastic polymer. Suitable examples of thermoplastic polymers include but are not limited to polyamide, such as polyamide 6, polyamide, 66 or polyamide 46; polyolefins, for example polypropylenes and polyethylenes; polyesters, such as polyethylene terephthalate, polybutylene terephthalate; polycarbonates; polyphenylene sulphide; polyurethanes and and mixtures thereof.

The thermoplastic polymer is preferably a polyolefin, more preferably a polyolefin chosen from the group of polypropylenes or elastomers of ethylene and α-olefin comonomer having 4 to 8 carbon atoms, and any mixtures thereof.

In one embodiment, preferably the thermoplastic polymer composition comprises at least 80 wt % of a thermoplastic polymer, for example at least 90 wt % polyolefin, at least 93 wt %, for example at least 95 wt %, for example at least 97 wt % of thermoplastic polymer, for example at least 98 wt % or for example at least 99 wt % of a thermoplastic polymer based on the thermoplastic polymer composition. In a special embodiment, the thermoplastic polymer composition consists of a thermoplastic polymer.

In another embodiment, the thermoplastic polymer composition comprises at least 60 wt %, for example at least 70 wt %, for example at least 75 wt % and/or at most 99 wt %, for example at most 95 wt %, for example at most 90 wt % thermoplastic polymer.

The polypropylene may for example be a propylene homopolymer or a random propylene-α-olefin copolymer or a heterophasic propylene copolymer.

A propylene homopolymer can be obtained by polymerizing propylene under suitable polymerization conditions. A propylene copolymer can be obtained by copolymerizing propylene and one or more other α-olefins, preferably ethylene, under suitable polymerization conditions. The preparation of propylene homopolymers and copolymers is, for example, described in Moore, E. P. (1996) Polypropylene Handbook. Polymerization, Characterization, Properties, Processing, Applications, Hanser Publishers: New York.

The α-olefin in the random propylene α-olefin copolymer is for example an α-olefin chosen from the group of α-olefin having 2 or 4 to 10 C-atoms, preferably ethylene, 1-butene, 1-hexene or any mixtures thereof. The amount of of α-olefin is preferably at most 10 wt % based on the propylene α-olefin copolymer, for example in the range from 2-7 wt % based on the propylene α-olefin copolymer.

Polypropylenes can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Heterophasic propylene copolymers are generally prepared in one or more reactors, by polymerization of propylene in the presence of a catalyst and subsequent polymerization of a propylene-α-olefin mixture. The resulting polymeric materials are heterophasic, but the specific morphology usually depends on the preparation method and monomer ratio.

The heterophasic propylene copolymer as defined herein consists of a propylene-based matrix and a dispersed ethylene-α-olefin copolymer.

The propylene-based matrix typically forms the continuous phase in the heterophasic propylene copolymer.

The propylene-based matrix consists of a propylene homopolymer and/or a propylene-α-olefin copolymer consisting of at least 70% by mass of propylene and up to 30% by mass of α-olefin, for example ethylene, for example consisting of at least 80% by mass of propylene and up to 20% by mass of α-olefin, for example consisting of at least 90% by mass of propylene and up to 10% by mass of α-olefin, based on the total mass of the propylene-based matrix.

Preferably, the α-olefin in the propylene-α-olefin copolymer is selected from the group of α-olefins having 2 or 4-10 carbon atoms and is preferably ethylene. Preferably, the propylene-based matrix consists of a propylene homopolymer.

The melt flow index (MFI) of the propylene-based matrix (before it is mixed into the composition of the invention) may be in the range of for example 0.3 to 200 dg/min as measured according to ISO1133 (2.16 kg/230° C.).

The propylene-based matrix is for example present in an amount of 50 to 85 wt % based on the total heterophasic propylene copolymer.

Besides the propylene-based matrix, the heterophasic propylene copolymer also consists of a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form.

The MFI of the dispersed ethylene α-olefin copolymer may vary between wide range and may for example be in the range from for example be in the range from 0.001 to 10 dg/min (measured according to ISO1133 (2.16 kg/230° C. as calculated using the following formula:

$$MFR EPR = 1 {0}^{⩓} ( \frac{Log MFR heterophasic - matrix content * Log MFR PP}{rubber content} )$$

wherein MFR heterophasic is the melt flow rate of the heterophasic propylene copolymer measured according to ISO1133 (2.16 kg/230° C.),

MFR PP is the MFR of the propylene-based matrix of the heterophasic propylene copolymer measured according to ISO1133 (2.16 kg/230° C.)

matrix content is the amount of propylene-based matrix in the heterophasic propylene copolymer in wt % and

rubber content is the amount of ethylene α-olefin copolymer in the heterophasic propylene copolymer in wt %.

The dispersed ethylene-α-olefin copolymer is for example present in an amount of 50 to 15 wt % based on the total heterophasic propylene copolymer.

For example, the amount of ethylene in the ethylene-α-olefin copolymer (RCC2) is in the range of 20-65 wt % based on the ethylene-α-olefin copolymer.

The amounts of the propylene-based matrix and the dispersed ethylene-α-olefin copolymer, as well as the amount of ethylene in the ethylene α-olefin copolymer may be determined by ¹³C-NMR, as is well known in the art.

In the heterophasic polypropylene, the sum of the total weight of the propylene-based matrix and the total weight of the dispersed ethylene-α-olefin copolymer is 100 wt %

The α-olefin in the ethylene-α-olefin copolymer is preferably chosen from the group of α-olefins having 3 to 8 carbon atoms and any mixtures thereof, preferably the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer. Examples of suitable α-olefins having 3 to 8 carbon atoms, which may be employed as ethylene comonomers to form the ethylene α-olefin copolymer include but are not limited to propylene, 1-butene, 1-pentene, 4-methyl-1-pentene, 1-hexen, 1-heptene and 1-octene.

The elastomer of ethylene and α-olefin comonomer having 4 to 8 carbon atoms may for example have a density in the range from 0.850 to 0.915 g/cm³. Such elastomers are sometimes also referred to as plastomers.

The α-olefin comonomer in the elastomer is preferably an acyclic monoolefin such as 1-butene, 1-pentene, 1-hexene, 1-octene, or 4-methylpentene.

Accordingly, the elastomer is preferably selected from the group consisting of ethylene-1-butene copolymer, ethylene-1-hexene copolymer, ethylene-1-octene copolymer and mixtures thereof, more preferably wherein the elastomer is selected from ethylene-1-octene copolymer. Most preferably, the elastomer is an ethylene-1-octene copolymer.

Preferably, the density of the elastomer is at least 0.865 g/cm³ and/or at most 0.910 g/cm³. For example, the density of the elastomer is at least 0.850, for example at least 0.865, for example at least 0.88, for example at least 0.90 and/or for example at most 0.915, for example at most 0.910, for example at most 0.907, for example at most 0.906 g/cm³. More preferable the density of the elastomer is in the range from 0.88 up to an including 0.907 g/cm³, most preferably, the density of the elastomer is in the range from 0.90 up to and including 0.906 g/cm³.

Elastomers which are suitable for use in the current invention are commercially available for example under the trademark EXACT™ available from Exxon Chemical Company of Houston, Tex. or under the trademark ENGAGE™ polymers, a line of metallocene catalyzed plastomers available from Dow Chemical Company of Midland, Mich. or under the trademark TAFMER™ available from MITSUI Chemicals Group of Minato Tokyo or under the trademark Nexlene™ from SK Chemicals.

The elastomers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomer s may also be prepared using traditional types of heterogeneous multi-sited Ziegler-Natta catalysts.

Preferably, the elastomer has a melt flow index of 0.1 to 40 dg/min (ISO1133, 2.16 kg, 190° C.), for example at least 1 dg/min and/or at most 35 dg/min. More preferably, the elastomer has a melt flow index of at least 1.5 dg/min, for example of at least 2 dg/min, for example of at least 2.5 dg/min, for example of at least 3 dg/min, more preferably at least 5 dg/min and/or preferably at most 30 dg/min, more preferably at most 20 dg/min, more preferably at most 10 dg/min measured in accordance with ISO 1133 using a 2.16 kg weight and at a temperature of 190° C.

Preferably, the amount of ethylene incorporated into the elastomer is at least 50 mol %. More preferably, the amount of ethylene incorporated into the elastomer is at least 57 mol %, for example at least 60 mol %, at least 65 mol % or at least 70 mol %. Even more preferably, the amount of ethylene incorporated into the elastomer is at least 75 mol %. The amount of ethylene incorporated into the elastomer may typically be at most 97.5 mol %, for example at most 95 mol % or at most 90 mol %.

The thermoplastic polymer composition may contain the usual additives, for instance nucleating agents and clarifiers, stabilizers, release agents, fillers, peroxides, plasticizers, anti-oxidants, lubricants, antistatics, cross linking agents, scratch resistance agents, high performance fillers, pigments and/or colorants, impact modifiers, flame retardants, blowing agents, acid scavengers, recycling additives, coupling agents, anti-microbials, anti-fogging additives, slip additives, anti-blocking additives, polymer processing aids and the like. Such additives are well known in the art. The skilled person will know how to choose the type and amount of additives such that they do not detrimentally influence the aimed properties. In a special embodiment, the thermoplastic polymer composition consists of the thermoplastic polymer and additives.

Preferably, the amount of impregnated continuous multifilament strand is in the range of 10 to 70 wt %, for example in the range from 15 to 70 wt %, for example in the range from 20 to 70 wt % or for example in the range from 25 to 70 wt % based on the sheathed continuous multifilament strands. Preferably, the sum of the amount of impregnated continuous multifilament strand and the polymer sheath is 100 wt %.

Although the invention has been described in detail for purposes of illustration, it is understood that such detail is solely for that purpose and variations can be made therein by those skilled in the art without departing from the spirit and scope of the invention as defined in the claims.

It is further noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

1. A process for the production of a tape comprising a plurality of impregnated continuous multifilament strands and a polymer sheath which intimately surrounds the plurality of impregnated continuous multifilament strands,
wherein each of the plurality of impregnated multifilament strands extends in the longitudinal direction,
wherein each of the plurality of impregnated continuous multifilament strands comprises at least one continuous glass multifilament strand, wherein the at least one continuous glass multifilament strand is impregnated with an impregnating agent,
wherein the process comprising the steps of
a) unwinding from a package the continuous glass multifilament strands,
b) applying the impregnating agent to the continuous glass multifilament strands to form the plurality of impregnated continuous multifilament strands,
c) placing the plurality of impregnated continuous multifilament strands in parallel alignment in the longitudinal direction and
d) applying a sheath of a thermoplastic polymer composition around the plurality of impregnated continuous multifilament strands of step c) to form the tape,
wherein steps c) and d) are performed in a die having a guiding means arranged for placing the plurality of impregnated continuous multifilament strands in parallel alignment in the longitudinal direction, wherein the plurality of impregnated continuous multifilament strands pass through a melt of the thermoplastic polymer composition inside of the die downstream of the guiding means.

2. The process according to claim 1, wherein the number of the impregnated continuous multifilament strands in the plurality of the impregnated continuous multifilament strands is at least 4.

3. The process according to claim 1, wherein the guiding means is provided with a plurality of extended holes in parallel alignment in the longitudinal direction and arranged in one plane, wherein each of the extended holes is arranged for accommodating one impregnated continuous multifilament strand.

4. The process according to claim 1, wherein the guiding means is provided with one extended hole having an elliptical cross section, wherein the extended hole is arranged for accommodating the plurality of impregnated continuous multifilament strands in one plane.

5. The process according to claim 1, further comprising the step e) of applying pressure and optional heat to the tape obtained by step d) preferably by steps of
e1) applying pressure on while optionally heating the tape and
e2) cooling and solidifying the product obtained by step e1),
wherein step e1) is optionally performed by sequential steps of
e1a) maintaining the tape of step d) in its melted state, e.g. by subjecting the tape of step d) to an elevated temperature, e.g. by hot rolls, flat belts, an oven or a belt press and
e2a) applying pressure on the tape obtained by step d) to adjust the thickness of the tape and compact the tape, e.g. by calendaring rolls.

6. The process according to claim 5, wherein the process further comprises step f) of cutting the tape obtained by step e) into desired length and wherein the tape obtained by step d) is subjected to step e) without cutting.

7. The process according to claim 1, further comprising step g) of cutting the tape obtained by step d) into desired length.

8. The process according to claim 7, further comprising the step h) of applying heat and pressure to the tape obtained by step g) optionally by sequential steps of
g1) heating and applying pressure on the tape and
g2) cooling and solidifying the product obtained by step g1), wherein g1) is optionally performed by sequential steps of
g1a) melting the tape of step d) and
g2a) applying pressure on the product obtained by step g1a) to adjust the thickness of the tape and compact the tape.

9. The process according to claim 1, wherein the continuous glass multifilament strands unwound in step a) and the impregnated continuous multifilament strands formed in step b) are not cut during steps a)-d).

10. The process according to claim 1,
wherein the amount of impregnating agent is 0.50 to 18 wt % based on the sheathed continuous multifilament strand, and/or
wherein the impregnating agent has a melting point of at least 20° C. below the melting point of the thermoplastic polymer composition and has a viscosity of from 2.5 to 200 cSt at 160° C., and/or
wherein the continuous glass multifilament strand comprises at most 2 wt % of a sizing composition based on the continuous glass multifilament strand, and/or
wherein the sheath consists of a thermoplastic polymer composition, wherein the thermoplastic polymer composition comprises at least 60 wt %, and/or
wherein the amount of the impregnated continuous multifilament strand is in the range of 10 to 70 wt % based on the sheathed continuous multifilament strand and wherein the amount of the sheath is in the range of 30 to 90 wt % based on the sheathed continuous multifilament strand and wherein the sum of the amount of impregnated continuous multifilament strand and the sheath is 100 wt %.

11. The process according to claim 1,
wherein the thermoplastic polymer comprises a polyolefin, and/or
wherein the melt flow rate of the thermoplastic polymer composition is in the range from 20 to 150 dg/min as measured according to ISO1133 (2.16 kg/230° C.), and/or
wherein the thermoplastic polymer composition comprises at least 80 wt % of the thermoplastic polymer based on the thermoplastic polymer composition.

12. The tape obtained by or obtainable by the process according to claim 1.

13. A laminate or woven fabric of a plurality of tapes of claim 12.

14. An article comprising the tape of claim 12.

15. The article of claim 14, wherein the article is a vehicle.
